(19) United States
(12) Patent Application Publication
(10) Pub. No.: US 2019/0294796 A1
(43) Pub. Date: Sep. 26, 2019

(54) RESOLVING ANOMALIES FOR NETWORK APPLICATIONS USING CODE INJECTION

(71) Applicant: Microsoft Technology Licensing, LLC, Redmond, WA (US)

(72) Inventors: Kuralmani Elango, Bothell, WA (US); Palaniraj Kaliyaperumal, Redmond, WA (US); Senthilkumar Manickavelu, Redmond, WA (US)

(21) Appl. No.: 15/934,756

(22) Filed: Mar. 23, 2018

(51) Int. Cl. G06F 21/56; H04L 29/06; G06F 8/70

(52) U.S. Cl. CPC G06F 21/568; G06F 8/70; H04L 63/1425

(57) ABSTRACT

Methods for resolving anomalies for network applications using code injection are performed by network services systems. Notifications for electronic communications incoming to executing applications are received and monitored on the network services system. The notifications are analyzed to identify anomalies in the electronic communications for executing applications. Application contexts associated with executing applications are determined, and code solutions are selected from a set of code solutions to correspondingly apply against the anomalies. Code solutions include code blocks, scripts, or code assemblies to resolve specific anomalies for executing applications. Code solutions are selected based on the application contexts and the one or more anomalies. Selected code solutions are injected into the first executing application to resolve or mitigate the anomalies. Injected code solutions may be permanent, or executing applications may be subsequently rolled back to pre-injection states based on rollback criteria.

### BACKGROUND

Downtime for maintenance, software fixes, updates, and upgrades is a common issue for network systems, applications, and services. For example, a web application hosted by a host system may experience degraded performance or failure due to unexpected high traffic volume or attacks. Current solutions to mitigate the degradation and repair failures require that the web application, and even the system hosting the web application, be taken offline and then restarted after maintenance, updates, or upgrades are performed. Additionally, when multiple web applications are hosted by a host system, downtime for mitigating issues with a hosted web application risks impacting others of the hosted web applications as well.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods for resolving anomalies for network applications using code injection are performed by network services systems. Notifications for electronic communications incoming to executing applications are received and monitored on the network services system. The notification are analyzed to identify anomalies in the electronic communications for executing applications. Application contexts associated with executing applications are determined, and code solutions are selected from a set of code solutions to correspondingly apply against the anomalies. Code solutions include code blocks, scripts, or code assemblies to resolve specific anomalies for executing applications. Code solutions are selected based on the application contexts and the one or more anomalies. Selected code solutions are injected into the first executing application to resolve or mitigate the anomalies. Injected code solutions may be permanent, or executing applications may be subsequently rolled back to pre-injection states based on rollback criteria.

For example, a network services system is described. The network services system may include a memory(ies) configured to store program instructions, a processor(s) configured to execute the program instructions. The program instructions may include first instructions configured to monitor notifications for electronic communications incoming to executing applications on the network services system, and second instructions configured to analyze the notifications and to identify one or more anomalies in the electronic communications for a first executing application of the executing applications based on the analysis. The program instructions may also include third instructions configured to determine an application context associated with the first executing application, select one or more code solutions from a set of code solutions to correspondingly apply against the one or more anomalies based on the application context associated with the first executing application and the one or more anomalies, each code solution in the set of code solutions comprising at least one of a code block or a code assembly and being configured to resolve a specific anomaly for executing applications, and inject the selected one or more code solutions into the first executing application.

Methods performed by the network services system, and computer-readable storage medium having program instructions recorded thereon that, when executed by a processing device, perform the methods for the network services system, are also described.

Further features and advantages, as well as the structure and operation of various examples, are described in detail below with reference to the accompanying drawings. It is noted that the ideas and techniques are not limited to the specific examples described herein. Such examples are presented herein for illustrative purposes only. Additional examples will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of a networked system for resolving anomalies for network applications using code injection, according to an example embodiment.

FIG. 2 shows a block diagram of a network services host system for resolving anomalies for network applications using code injection, according to an example embodiment.

FIG. 3 shows a flowchart for resolving anomalies for network applications using code injection, in accordance with an example embodiment.

FIG. 4 shows a flowchart for resolving anomalies for network applications using code injection, in accordance with an example embodiment.

FIG. 5 shows a block diagram of a code solution resolving anomalies for network applications using code injection, in accordance with an example embodiment.

FIG. 6 shows a flowchart for resolving anomalies for network applications using code injection, in accordance with an example embodiment.

FIG. 7 shows a block diagram of a network services host system for resolving anomalies for network applications using code injection, in accordance with an example embodiment.

FIG. 8 shows a flowchart for resolving anomalies for network applications using code injection, in accordance with an example embodiment.

FIG. 9 shows a block diagram of an example computing device that may be used to implement embodiments.

The features and advantages of embodiments will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description discloses numerous embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the discussion, unless otherwise stated, adjectives such as “substantially,” “approximately,” and “about” modifying a condition or relationship characteristic of a feature or features of an embodiment of the disclosure, are understood to mean that the condition or characteristic is defined to be within tolerances that are acceptable for operation of the embodiment for an application for which it is intended.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures and drawings described herein can be spatially arranged in any orientation or manner.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

Section II below describes example embodiments for resolving anomalies for network applications using code injection, where Section II.A describes example system embodiments, Section II.B describes example code solution embodiments, and Section II.C describes example application and interceptor embodiments. Section III below describes computing device embodiments that may be used to implement features of the embodiments described herein. Section IV below describes additional examples and advantages, and Section V provides some concluding remarks.

### II. Example Embodiments

Methods, systems, apparatuses, devices, and computer program products are provided for resolving anomalies for network applications using code injection. The described embodiments provide for the injection of code solutions for executing applications when anomalies associated with the executing application occur. Code solutions may include various types of code such as program code, scripts, code assemblies (e.g., library files), and/or the like, as well as additional information for identification and selection thereof, that is applied through injection mechanisms against anomalies. Thus, the described embodiments enable “code solution aware” hosting systems and applications that dynamically handle anomalies via an extensible platform, while also maintaining the ability to host applications for which code solutions will not be provided. The embodiments herein are scalable to enable servicing of any number of applications concurrently, e.g., several, tens, hundreds, or more. Any types of services including real-time eventing, applications, and data sources may be implemented in accordance with the described embodiments.

For example, a hosting system that executes hosted applications may receive and monitor data and information of incoming communications and requests for the hosted applications using network services. The network services analyze the data and information to detect and identify anomalies associated with incoming communications and requests. Anomalies may include sudden increases in volume of incoming network traffic and/or attacks/fraudulent activities therein. When anomalies are detected, the network services determine an application context that relates to the anomalies. For instance, data and information such as application information, types and/or numbers of certain communications/requests received by an executing application, communication/request volume (expected and/or actual), information for users associated with communications/requests, channels utilized, etc., may be used to determine a current context for the executing application. Based on the application context and the anomaly(ies), one or more code solutions are selected to be injected for the executing application. Code solutions may be generated and/or maintained as sets of code solutions (e.g., libraries) and each code solution may include lines or blocks of program/computer code, code assemblies, scripts, reference information, and/or the like. Thus, the code solutions may be configured to resolve a specific anomaly(ies) for executing applications given a current application context.

Code solutions may perform functions, or cause functions to be performed, to address anomalies. For example, incoming communications/requests for executing applications may be drained/ignored, limited, deferred, and/or handled based on priority. Code solutions may also trigger scaling of application channels and/or allocation or reallocation of system resources to handle anomalies. In embodiments, new channels for applications or subroutines thereof may be created when applications or subroutines degrade or fail.

Code solutions may be used multiple times for the same or different applications, and new code solutions may be generated and added if existing code solutions are not applicable to an anomaly experienced by an executing application. In this way, performance of applications and computing systems is improved through dynamic injection of code solutions for different executing applications at a logically centralized system. Anomalies for specific application contexts are determined and identified, and then resolved on a per-issue basis for each application regardless of application function or type. The described embodiments of code solution injection for executing applications enables network traffic and load to be balanced and/or reduced as required for specific applications, and apply to any type of anomaly and/or application context. Additionally, dynamic allocation of resources/scaling is enabled for executing applications and the hosting system.

Upon resolution of anomalies, executing applications serviced with code solutions to address the anomalies may be returned to a prior state via rollback or be returned to prior operations through dormancy of the injected code solutions.

In other words, the embodiments disclosed herein resolve anomalies for network applications using code injection while the network applications are executing. These and further embodiments are described in greater detail as follows.

### A. Example Embodiments for Systems that Resolve Anomalies for Network Applications using Code Injection

In embodiments, systems and devices may be configured in various ways for resolving anomalies for network applications using code injection. For instance, FIG. 1 is a block diagram of a network services host system 100 (“system 100”), according to embodiments. System 100 is configured to resolve anomalies for network applications using code injection. As shown in FIG. 1, system 100 includes a client device 102, a network services host system 104, a network services administrator client 116, and a developer system 114 which may communicate with each other over a network 110. It should be noted that any numbers of client devices, network services host systems, developer systems, and network services administrator client devices may be present in various embodiments. Additionally, any combination of the components illustrated in FIG. 1 may be present in system 100, according to embodiments.

As noted above, client device 102, network services host system 104, network services administrator client 116, and developer system 114, are communicatively coupled via network 110. Network 110 may comprise any type of communication links that connect computing devices and servers such as, but not limited to, the Internet, wired or wireless networks and portions thereof, point-to-point connections, local area networks, enterprise networks, and/or the like.

Developer system 114 may comprise one or more server computers or computing devices, which may include one or more distributed or “cloud-based” servers, productivity clients, or any other type of computing device on which development of web- or network-applications may be undertaken. Developer system 114 may be configured to enable developers to develop and/or publish web- or network-applications, such as platforms for video game streaming and out-of-game activities, online store fronts, data stores, applications for the “Internet of Things” (IoT), and/or any other type of web service or online application that may be hosted by a host service. Accordingly, developer system 114, or storage associated therewith, may include one or more of applications 106.

Applications 106 and/or developer system 114 may include program code, code assemblies, scripts, or applications, which may be provided from network services host system 104, network services administrator client 116, etc., for gathering or intercepting application data, communications, exceptions, anomalies, and/or the like, as described in further detail herein. Applications 106 may be provided to network services host system 104 electronically or otherwise for hosting thereof, over a network as described herein, and/or as encoded program instructions on computer readable storage media to be read, accessed, and/or executed by network services host system 104.

Network services host system 104 may comprise one or more server computers or computing devices, which may include one or more distributed or “cloud-based” servers. Network services host system 104 may also include internal and/or external storage, such as but not limited to, an external storage 120. Any internal and/or external storage may be distributed, according to embodiments. Network services host system 104 is configured to host applications 106 which are executed for deployment by network services host system 104. Applications 106 may be developed and provided by a developer via developer system 114. During the execution of applications 106, users may interface with applications 106 via network services host system 104 for various functions associated therewith, as described below. It is contemplated herein that any number of applications 106 may be stored and/or executed by network services host system 104. Remote databases or storage, such as storage 120, communicatively connected via network 110, may be utilized as part of network services host system 104.

As illustrated, network services host system 104 also includes network services 108. Network services 108 may be configured in various ways for resolving anomalies for applications 106 using code injection. For instance, network services 108 are configured to inject code solutions into applications 106 while applications 106 are executing on network services host system 104, according to embodiments. That is, network services 108 may receive and monitor notifications from applications 106, identify anomalies in electronic communications associated with applications 106, and select code solutions for injection into applications 106 based on contexts of executing applications 106 and the anomalies. Network services 108 may be implemented as hardware, software, firmware, or any combination thereof.

Network services administrator client 116 may be any type of computing device or computing system, including a terminal, a personal computer, a laptop computer, a tablet device, a smart phone, a server, etc., that may be used by administrators to interface and/or communicate with network services host system 104. For instance, administrators (including software developers, engineers, etc.) for network services host system 104 may generate and/or provide code solutions 118 for anomalies of applications 106, where such code solutions 118 are appropriately injected for applications 106 by network services 108, as described herein. In some embodiments, code solutions 118 may be automatically generated by network services administrator client 116 and/or network services host system 104 according to machine learning algorithms. Code solutions 118 may also be stored by network services host system 104, as described below.

Client device 102 may be any type of computing device or computing system, including a game console (e.g., any type of Xbox™ or Xbox One™ console from Microsoft Corporation of Redmond, Wash., etc.), a terminal, a personal computer, a laptop computer, a tablet device, a smart phone, etc., that may be used by users to interface and/or communicate with applications 106 executing on network services host system 104. Users may interface and/or communicate with applications 106 executing on network services host system 104 via one or more user interfaces (UIs) such as UI 112. Each of UI(s) 112 may be a specific UI associated with an application of applications 106, a specific UI associated with client device 102, a specific UI associated with an operating system as described herein, a general or generic UI, and/or the like. From UI 112 and/or client device 102, users are enabled to provide requests and/or data to applications 106. Requests and/or data may be related to user information, user accounts, business information, gaming information or features, online shopping, developer promotions, and/or the like, as related to specific applications of applications 106 that are executing on network services host system 104.

Client device 102 may be configured to provide user authentication/credential information over network 110 to an application of applications 106 that are executing on network services host system 104 to interface/communication therewith. In embodiments, a user may utilize UI 112 for such authentication. In embodiments, client device 102 may include a stored instance of UI 112, which may be received from applications 106 or which may be a component of client device 102. In embodiments, UI 112 may be any type of service/application UI, browser, client or electronic communication application, messaging application, portal, and/or the like.

Note that as described herein, embodiments are applicable to any type of system where an application executed by the system receives requests and other communications over a network. In one example, network services host system 104 is a “cloud” platform/architecture for hosting applications 106. A cloud platform/architecture may include a networked set of computing resources, including servers, routers, etc., that are configurable, shareable, provide data security, and are accessible over a network such as the Internet. Applications 106 may thus be cloud applications run on the resources, often atop operating systems that run on the resources, for entities that access the applications over the network. A cloud platform may support multi-tenancy, where cloud platform-based software, such as network services 108, services multiple tenants, with each tenant including one or more users who share common access to software services of the cloud platform. Furthermore, a cloud platform may support hypervisors implemented as hardware, software, and/or firmware that run virtual machines (emulated computer systems, including operating systems) for tenants. A hypervisor presents a virtual operating platform for tenants.

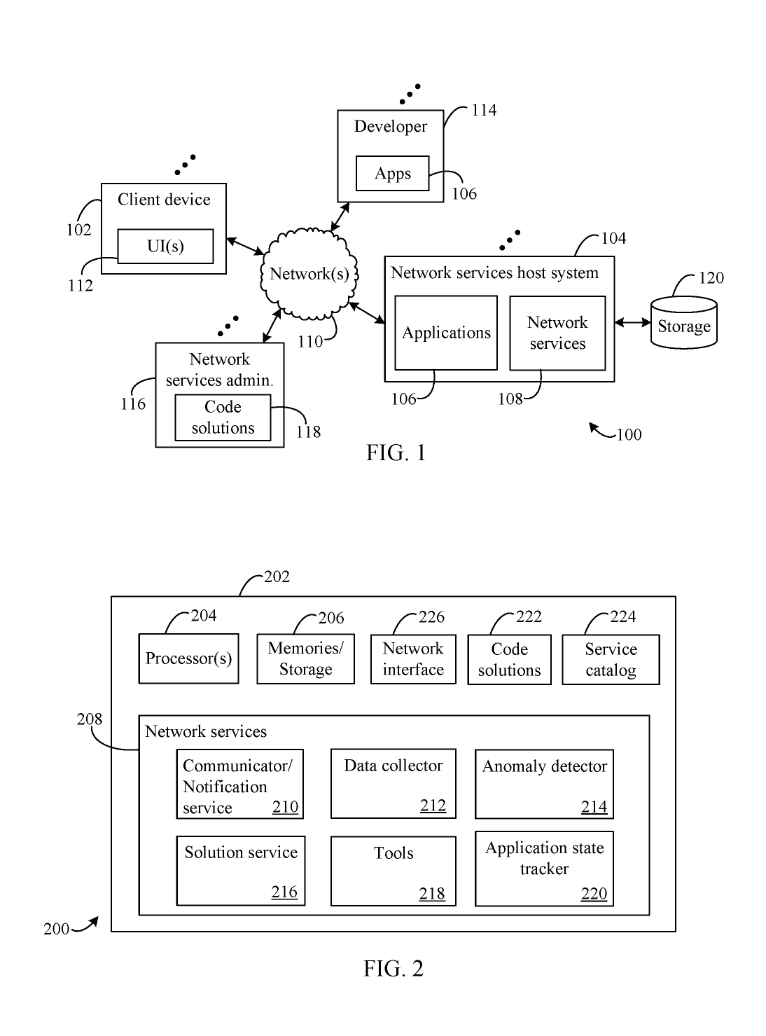

Accordingly, network services host system 104 may be configured in various ways resolve anomalies for network applications using code injection. For example, FIG. 2 is a block diagram of a network services host system 200 (“system 200” herein) configured to resolve anomalies for network applications using code injection. System 200 may be an embodiment of network services host system 104 of FIG. 1. System 200 is described as follows.

System 200 includes a network services host 202, which may be any type of server computer or computing device, as mentioned elsewhere herein, or as otherwise known, including cloud-based server implementations. As shown in FIG. 2, system 200 and network services host 202 includes one or more of a processor (“processor”) 204, one or more of a memory and/or other physical storage device (“memory”) 206, one or more network interfaces (“network interface”) 226, and network services 208 that may be an embodiment of network services 108 of FIG. 1. System 200 may also include code solutions 222, which may be an embodiment of code solutions 108 of FIG. 1, as well as a service catalog 224. System 200 may also include additional components (not shown for brevity and illustrative clarity) including, but not limited to, components and subcomponents of other systems herein, and hosted applications, such as applications 106, etc., as well as those described below with respect to FIG. 10, such as an operating system.

Processor 204 and memory 206 may respectively be any type of processor circuit or memory that is described herein, and/or as would be understood by a person of skill in the relevant art(s) having the benefit of this disclosure. Processor 204 and memory 206 may each respectively comprise one or more processors or memories, different types of processors or memories, remote processors or memories, and/or distributed processors or memories. Processor 204 comprises circuitry that is configured to execute computer program instructions such as but not limited to embodiments of network services 208, which may be implemented as computer program instructions for resolving anomalies for network applications using code injection, as described herein. Memory 206 is configured to store such computer program instructions/code, as well as to store other information and data described in this disclosure including, without limitation, network services 208, code solutions 222, service catalog 224, applications 106, etc. In some embodiments, storage 120 of FIG. 1 may also be included in system 200, e.g., as a portion of memory 206.

Network interface 226 may be any type of wired and/or wireless network adapter, modem, etc., configured to enable system 200 to communicate with other devices over a network, such as communications between system 200 and other devices utilized in a network like network 110 as described herein, e.g., those described above with respect to FIG. 1 and system 100.

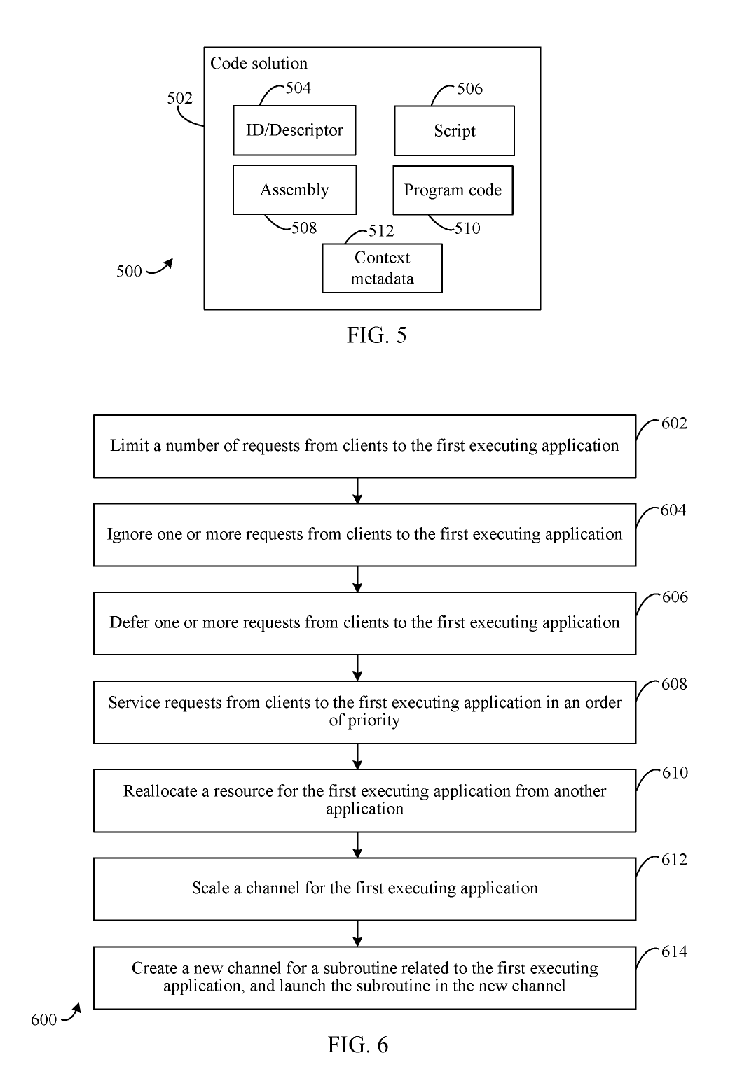

Code solutions 222 may include, without limitation, various types of code such as program code, scripts, code assemblies (e.g., library files), and/or the like. Code solutions 222 may be stored as a set of code solutions in memory 206, which may be referred to as a code solution library. Code solutions 222 may also include identifiers (IDs) or descriptors that identify particular code solutions, as well as metadata for contexts, as described in further detail below with respect to FIG. 5. Code solutions 222 are configured to be injected into execution stacks or pipelines of executing applications hosted by system 200, e.g., applications 106, to resolve anomalies for different application contexts, as described in further detail below with respect to FIG. 6.

Service catalog 224 may include, without limitation, information associated with applications (e.g., applications 106) hosted and executed by system 200 that relates to the use of code solutions 222. For instance, service catalog 224 may include a list of hosted applications and indications as to whether or not injection of code solutions 222 is desired and/or allowed by the hosted applications. In embodiments, allowed types of code solutions for applications may also be indicated. For each application in service catalog 224, there may also be included additional information about the applications such as, but not limited to, communication protocols utilized by the applications, program code/script types compatible with the applications (e.g., for injection of code solutions 222), indications of priorities or critical statuses for different types of requests/communications or channels, and/or the like.

Network services 208 includes a plurality of components for performing the techniques described herein for resolve anomalies for network applications using code injection. As shown, network services 208 includes communicator/notification service 210, a data collector 212, an anomaly detector 214, a solution service 216, tools 218, and an application state tracker 220. While shown separately for illustrative clarity, in embodiments, one or more of communicator/notification service 210, data collector 212, anomaly detector 214, solution service 216, tools 218, and/or application state tracker 220 may be combined together and/or as a part of other components of system 200. In some embodiments, less than all of the components of network services 208 illustrated in FIG. 2 may be included. In software implementations, one or more components of network services 208 and/or network services host 202 may be stored in memory 206 and may be executed by processor 204.

Communicator/notification service 210 is configured to receive and/or transmit electronic communications for network services 208 of system 200. For instance, communicator/notification service 210 is configured to receive notification and/or indications related to communications incoming to hosted applications from a network. Additionally, data associated with hosted applications that relates to application state (e.g., the current configuration of an application) may be received by communicator/notification service 210 and provided to data collector 212. Communicator/notification service 210 is also configured to provide notifications of detected anomalies for applications. For example, notifications may be provided to network services administrator client 116, to applications 106, to solution service 216, and/or the like, for determinations of whether code solutions 222 may be implemented for anomalies.

Data collector 212 is configured to collect or aggregate data related to configurations of applications, e.g., for application states, as well as indications or notifications for electronic communications incoming to executing applications on the network services system received by communicator/notification service 210. In embodiments, data collector 212 may extract data and information from received notifications and provide such extracted data and information to anomaly detector 214, solution service 216, and/or application state tracker 220. The data and information may include application information, types or numbers of types of requests/communications received by an application, request/communication volume, time to service requests/communications, information for users associated with requests/communications, exceptions, channels utilized, etc., as well as application configuration information including, but without limitation, code solutions implemented, resource allocations for applications, data and/or types of data used by the application, etc.

Anomaly detector 214 is configured to determine or identify one or more anomalies associated with executing applications. Anomaly detector 214 may, for example, determine or identify an increase of requests/communications for an application, repeated requests/communications from a single user or a group of users (or other types of attacks on the application), a response or processing latency for requests/communications handled by an application, etc. Anomaly detector 214 is configured to make such determinations and/or identifications based on information provided from data collector 212. In embodiments, anomaly detector 214 may be configured to monitor incoming requests/communications directly, in addition to or in lieu of, information and data provided by data collector 212 when determining or identifying anomalies.

Solution service 216 is configured to determine ones of code solutions 222 that may be injected for executing applications and applied against detected anomalies. Solution service 216 may be configured to select ones of code solutions 222 based on data and information received from data collector, such as data/information related to the current application context, and based on the anomaly identified by anomaly detector 214. For example, a code solution of code solutions 222 may include or be associated with context metadata that indicates an application context and/or an anomaly for which the code solution is applicable. In embodiments for which an applicable code solution is not found in code solutions 222, solution service 216 may dynamically generate an applicable code solution, or may provide a request via communicator/notification service 210 to network services administration client 116 for generation of the applicable code solution. Generating and/or providing requests for code solutions may be based on machine learning algorithms, in embodiments, e.g., to determine types of code solutions to be generated. Generated code solutions may be added to the stored set of code solutions in code solutions 222. Upon selection of an applicable code solution(s), solution service is configured to inject the code solution for the executing application to resolve the anomaly.

Tools 218 may include one or more protocol engines, application programming interfaces (APIs), and/or communication interfaces by which communications with executing applications may be performed. Components of tools 218 may also be utilized with code injection techniques described herein, e.g., by solution service 216, to properly inject code solutions for executing applications.

Application state tracker 220 is configured to track states of executing applications. Application states may thus be tracked externally to the application itself by application state tracker 220 of network services 208. Application state tracker 220 is configured to utilize data and information provided by data collector 212, as described above. For instance, application configuration information including, but without limitation, code solutions implemented, resource allocations for applications, data and/or types of data used by the application, etc., may be used by application state tracker 220 to track a current state of an application. Application states thus determined may be saved upon injection of code solutions and used for subsequent application state rollbacks when or if code solutions are removed or caused to become dormant, as described below.

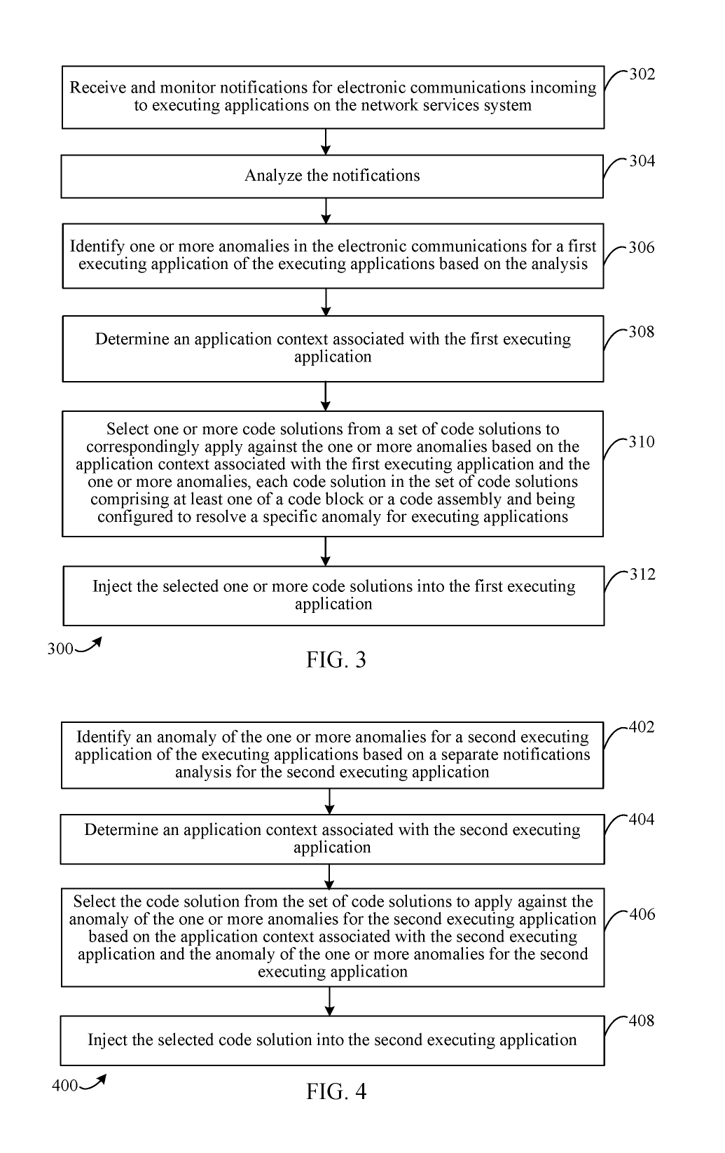

Accordingly, network services 208 may operate in various ways to enable the resolution of anomalies for network applications using code injection. For instance, FIG. 3 shows a flowchart 300 for resolving anomalies for network applications using code injection, according to an example embodiment. Network services 208 may operate according to flowchart 300, in an embodiment. Further structural and operational examples will be apparent to persons skilled in the relevant art(s) based on the following description. Flowchart 300 is described as follows with respect to system 100 of FIG. 1 and system 200 of FIG. 2.

Flowchart 300 begins at step 302. In step 302, notifications for electronic communications incoming to executing applications on the network services system are received and monitored. For instance, communicator/notification service 210 of network services 208 in FIG. 2 is configured to receive notifications for electronic communications incoming to executing applications. In embodiments, received notifications may be monitored by data collector 212 to extract information and data related to the application from the notifications. In this way, communications and requests to hosted applications are monitored so that anomalies may be detected.

In step 304, the notifications are analyzed. For example, anomaly detector 214 of FIG. 2 may analyze the received notifications according to data extracted therefrom as in step 302. Anomaly detector 214 may utilize data and information such as application information, types of requests/communications received by an application, request/communication volume, information for users associated with requests/communications, etc., as well as application configuration information including, but without limitation, code solutions implemented, resource allocations for applications, data and/or types of data used by the application, etc., to analyze notifications. Anomaly detector 214 may be configured to compare and correlate data with expected application communication behaviors and/or with known anomalies and/or anomalous behaviors. In embodiments, solution service 216 may also be configured to analyze the notifications, e.g., using some or all of the data described above, in determining application contexts.

In step 306, one or more anomalies in the electronic communications for a first executing application of the executing applications are identified based on the analysis. For instance, anomaly detector 214 is configured to identify anomalies based on the analysis in step 304. That is, based on the analysis, a specific anomaly or type of anomaly for the application may be identified by anomaly detector 214. As non-limiting examples, anomaly detector 214 may identify an unexpected increase in communication/request volume, multiple communications/request from the same Internet Protocol (IP) address or a range of IP addresses in a subnet, and/or the like based on the analyzed data in step 304. Similarly, anomalies may be identified based on expected versus actual numbers of communications/requests per time period, latency of responses by an application to communications/requests, and/or the like.

In step 308, an application context associated with the first executing application is determined. In embodiments, as noted above, solution service 216 may be configured to analyze application information and data from the notifications, e.g., as extracted by data collector 212, in determining contexts for executing applications. For instance, application information may include, without limitation, information related to a user associated with the electronic communications, an expected number for the electronic communications based on the first executing application, an actual number of the electronic communications for the first executing application, and/or a type of request associated with the electronic communications. That is, in additional to communication/request volumes and identities of users of the communications/requests, types of communications (e.g., business critical versus non-critical, the use of the communications or requests within a specific application, etc.) provide context information for an application. In embodiments, solution service 216 may be configured to determine an application context based on a threshold number of a specific type of communication/request, or attribute thereof, such that the context, or “what the application is doing,” is apparent.

In step 310, one or more code solutions are selected from a set of code solutions to correspondingly apply against the one or more anomalies based on the application context associated with the first executing application and the one or more anomalies. In embodiments, each code solution in the set of code solutions comprises at least one of a code block or a code assembly and being configured to resolve a specific anomaly for executing applications. Code solutions may also include scripts and any other form of injectable information for addressing anomalies as described herein. For example, solution service 216 may be configured to select one or more code solutions from a stored set of code solutions in code solutions 222 to apply against one or more identified anomalies, e.g., from step 306. Solution service 216 may select a code solution(s) of code solutions 222 to apply against one or more anomalies. In embodiments, solution service may select code solutions based on a comparison of identified anomalies and application context with context metadata of the code solutions. That is, a code solution may include information to associate the code solution with a specific anomaly type and/or a specific application context.

As noted above, code solutions may be generated if an applicable code solution is not present in the stored set of code solutions 222. Once generated, new code solutions may be selected for executing applications, for the context determined in step 308, against the anomaly(ies).

In step 312, the selected one or more code solutions are injected into the first executing application. For instance, solution service 216 is configured inject code solutions selected in step 310 into an application. Code solutions may be injected via tools 218, as described above, or as otherwise known, and may be injected into an application stack or execution pipeline or otherwise according to the specific application and code solution.

As a non-limiting, illustrative example, a hosted application executing on system 200 may provide communication notifications to network services 208, as described above. During the course of receiving and monitoring the notifications, anomaly detector 214 may identify an anomaly with the executing application. For instance, anomaly detector 214 may identify an increase in communications/requests received by the executing application (e.g., an expected 1,000 communications/requests received per time period has increased to 10,000 per time period) causing an unacceptable amount of latency in times to reply to each communication/request. Solution service 216 then determines an application context based on data/information collected by data collector 212, and selects a code solution of code solutions 222 to inject into the executing application. In embodiments, solution service 216 may also reference service catalog 224 to determine a type(s) of code solutions allowed by the application before selecting the code solution to be injected.

The extensible architecture of system 200 described above enables a network services platform that can inject code solutions for any type of application and application context over a range of different anomalies.

Additionally, the described embodiments allow for a single code solutions to be injected for different applications with similar contexts that have similar anomalies. That is, even though two hosted and executing applications may be unrelated to each other, the same code solution may be applied against an anomaly affecting both applications when the applications share similar contexts.

For instance, FIG. 4 shows a flowchart 400 for resolving anomalies for network applications using code injection, according to an example embodiment. Network services 208 may operate according to flowchart 400. Flowchart 400 may be a further embodiment of flowchart 300 of FIG. 3. Further structural and operational examples will be apparent to persons skilled in the relevant art(s) based on the following description. Flowchart 400 is described as follows with respect to system 100 of FIG. 1 and system 200 of FIG. 2.

Flowchart 400 begins at step 402. In step 402, an anomaly of the one or more anomalies is identified for a second executing application of the executing applications based on a separate notifications analysis for the second executing application. For example, as noted above in step 306 of flowchart 300 in FIG. 3, one or more anomalies are identified for a first executing application based on an analysis of notifications (see also steps 302 and 304). In step 402, a separate analysis of notifications for a second executing application is performed so that an anomaly previously identified for the first executing application is also identified for the second executing application.

In step 404, an application context associated with the second executing application is determined. For instance, as noted above for step 308 of flowchart 300, solution service 216 may be configured to determine a context for an executing application. In the example here for flowchart 400, solution service 216 is configured to determine a context for the second executing application based on data and information collected by data collector 212 from monitored notifications of the second executing application. The determined context may be the same as, or similar to, the context of the first executing application.

In step 406, the code solution from the set of code solutions is selected to apply against the anomaly of the one or more anomalies for the second executing application based on the application context associated with the second executing application and the anomaly of the one or more anomalies for the second executing application. For example, solution service 216 may be configured to select the same code solution for the second executing application as was selected for the first executing application in step 310 of flowchart 300. That is, even though the second executing application is different from the first executing application, in this case where the application context and anomaly are similar, the same code solution may be selected.

In step 408, the selected code solution is injected into the second executing application. Similar to step 312 of flowchart 300, solution service 216 is configured inject the selected code solution into the second executing application. As noted previously, code solutions may be injected via tools 218 or as otherwise known, and may be injected into an application stack or execution pipeline or otherwise according to the specific application and code solution. Injecting the same code solution for the second executing application may be performed subsequently, concurrently, or partially concurrently with the injection of the code solution for the first executing application. In embodiments, where the code solution for the first executing application is generated responsive to determining the context for the first executing application (e.g., as in step 308) and prior to selecting the code solution (e.g., as in step 310), the same, generated code solution may also be applied against the anomaly for the second executing application as described above.

Accordingly, flowchart 300 and flowchart 400 (and network services 208 of system 200) enable resolution of anomalies for network applications using code solution injection while the hosted applications are executing. In this way, performance of applications and computing systems is improved by dynamically injecting code solutions for different executing applications at a logically centralized system such that anomalies for specific application contexts are determined and identified, and then resolved on a per-issue basis for each application. Additionally, the described embodiments provide an extensible code solution library where one code solution may be used for different applications, new code solutions can be generated for specific cases, and code solutions for any anomaly in any given application context can be selected and applied regardless of application type.

### B. Example Embodiments for Code Solutions

As described herein, code solutions may be injected for executing applications to handle anomalies. A code solutions may include any code solution content described herein. Code solutions may be stored as a set of code solutions in a memory or a storage, such as in a code solution library. Code solutions are configured to be injected into execution stacks or pipelines of executing applications hosted by systems herein to resolve anomalies for different application contexts by performing functions, causing executing applications to function in specific ways, and/or modifying an executing application's utilization of hardware/software of its hosting system. FIG. 5 and FIG. 6 are now described.

In FIG. 5, a block diagram of a code solution 500 for resolving anomalies for network applications using code injection is shown, according to an example embodiment. Code solution 500 may be an embodiment of one of code solutions 222, described above with respect to system 200 of FIG. 2. Code solutions, such as code solution 500 and/or code solutions 222, may include without limitation various types of code such as program code, scripts, code assemblies (e.g., library files), and/or the like. The content of code solutions 222 may include un-compiled code, compiled code, and/or executable code, according to embodiments. It is contemplated that fewer or additional components than those illustrated may be included in embodiments of code solution 500, as would be understood by those of skill in the relevant art(s) having the benefit of this disclosure.

As shown, code solution 500 may be encapsulated as a file or in wrapper or by other techniques, generally, such as a container 502. Container 502 may be configured to distinguish code solution 500 as a discrete code solution entity with respect to other code solutions, and may also be configured to facilitate injection in embodiments. Code solution 500 may also include identifiers (IDs) or descriptors 504 (ID 504) that uniquely identifies code solution 500. ID 504 may include a code solution name or other alphanumeric identifier, and may include some description, keywords, or other information related to the identification of code solution 500.

Code solution 500 may include one or more of a script(s) 506, an assembly(ies) 508, and/or program code 510. Script(s) 506 may include one or more scripts that may be in any scripting language. Assembly(ies) 508 may be one or more executable program code assemblies, and may include executable portions and reference data/information. Assembly(ies) 508 may be library files, such as dynamic link libraries (DLLs) and/or the like, and may be configured to perform, or cause, one or more functions through execution thereof. Program code 510 may include one or more lines, blocks, snippets, functions, procedures, etc., of computer code that may be in one or more programming languages.

Context metadata 512 may include data/information related application contexts and/or anomalies. For example, as noted above, a code solution is applied against an anomaly for a given application context. Accordingly, context metadata 512 may include data/information that identifies a specific anomaly or a number of anomalies against which code solution 500 is applicable. Additionally, context metadata 512 may include data/information that identifies a specific application context or a number of application contexts appropriate for application of code solution 500. In this way, code solution 500 may be properly selected, e.g., by solution service 216 of system 200 in FIG. 2 as described in step 310 of flowchart 300 in FIG. 3, based on an identified anomaly(ies) and a determined application context(s) as described in steps 302-308 of flowchart 300.

It is also contemplated that in some embodiments, code solution 500 may be specifically associated with a certain application, and an indication of this association may also be included in context metadata 512.

Code solution 500 is configured to be injected into execution stacks or pipelines of executing applications hosted by a system, such as system 200 of FIG. 2, to resolve anomalies for different application contexts, as described in step 310 of flowchart 300 in FIG. 3. As previously described, code solutions such as code solution 500 are injected for executing applications to perform functions, cause executing applications to function in specific ways, and/or to modify an executing application's utilization of hardware/software of its hosting system.

FIG. 6 shows a flowchart 600 for resolving anomalies for network applications using code injection. Executing applications, systems such as system 200, and/or code solutions such as code solution 500, as described herein, may operate according to flowchart 600. Flowchart 600 may be a further embodiment of flowchart 300 of FIG. 3 and/or flowchart 400 of FIG. 4. In embodiments, one, some, or all of the steps of flowchart 600 may be performed for a given code solution. Further structural and operational examples will be apparent to persons skilled in the relevant art(s) based on the following description.

Flowchart 600 beings with step 602. In step 602, a number of requests from clients to the first executing application is limited. For example, code solution 500 may be injected to limit communications/requests from clients. That is, in cases where the volume of incoming communications/requests to the executing application increases significantly past a point at which timely servicing communications/requests is impeded or performance of the application and/or hosting system is degraded, the injection of code solution 500 may enable the executing application to only accept a specified number of communications/requests at one time.

In step 604, one or more requests from clients to the first executing application are ignored. For instance, code solution 500 may be injected to ignore, i.e., drain, requests from clients. That is, in cases where the volume of incoming communications/requests to the executing application increases significantly past a point at which timely servicing communications/requests is impeded or performance of the application and/or hosting system is degraded, the injection of code solution 500 may enable the executing application to ignore a portion, or a specified number, of communications/requests. Communications/requests may be ignored based on a type of request, an identity of a user/requestor, and/or the like. In embodiments, these ignored communications/requests may be discarded.

In step 606, one or more requests from clients to the first executing application are deferred. For example, code solution 500 may be injected to defer requests from clients. That is, in cases with increased incoming communications/requests volumes, the injection of code solution 500 may enable the executing application to defer one or more communications/requests, e.g., by queuing methods such as first-in-first-out, etc. Communications/requests identified as attacks may be deferred or off-loaded through a document database maintained in a memory of the hosting system, e.g., memory 206 of system 200 or storage 120 of system 100. In such cases, an analysis of the contents of the document database may be performed to determine if any communications/requests are actual attacks (where the determined attacks may be discarded) and to identify false positives that can then be serviced.

In step 608, requests from clients to the first executing application are serviced in an order of priority. For instance, code solution 500 may be injected to cause communications/requests from clients to be serviced in order of a predetermined priority (e.g., high to low) based on types of communications/requests. As an example, business critical communications/requests may be serviced prior to others—in a case where purchases made with respect to an executing application increase based on a promotion increase, purchase communications/requests may be given a higher priority than communications/requests to the executing application for distribution of coupons or credits subsequent to a purchase. In another example, the handling of fraud or an attack on an executing application may be given higher priority than requests for account status. Lower priority communications/requests may be limited as in step 602, ignored as in step 604, and/or deferred as in step 606.

In step 610, a resource for the first executing application is reallocated from another application. For example, code solution 500 may be injected to reallocate hosting system resources from one executing application to handle a higher volume of communications/requests from clients for another executing application. As an example, when a first executing application experiences an increase in communication/request volume, resources of a hosting system, such as but without limitation, memory, processing, networking resources of system 200 in FIG. 2, currently utilized for one or more other executing applications may be reallocated to handle the increase for the first executing application. Because system 200 hosts each of these applications, code solution 500, when injected, may cause such reallocation based on overall resource usage without negatively impacting the performance of the other executing applications if they are under-utilizing system resources.

In step 612, a channel for the first executing application is scaled. For instance, similar to the description of step 610 above, additional resource may be allocated to the first executing application to handle increased communication/request volume, but here the injection of code solution 500 causes the resource allocation may be made from unallocated resources to scale the channel for the first executing application. Scaling may be performed with respect to resources related to memory, processing, networking, etc., of the system.

In step 614, a new channel for a subroutine related to the first executing application is created, and the subroutine is launched in the new channel. For example, code solution 500 may be injected to cause the creation of a new channel in the hosting system for one or more subroutines of the first executing application if application or system performance degrades or fails. The new channel may be created from unallocated resources as similarly described above in step 612, or may be create from reallocated resources as similarly described above in step 610.

Thus, the described code solution injection for executing applications enables network traffic and load to be balanced and/or reduced as required for any type of anomaly and/or application context, and enables dynamic allocation of resources/scaling. Accordingly, performance of the executing applications and the underlying host system are improved for network load, processing cycles, and memory allocation. The current state of the art lacks an architecture for dynamic injection of code solutions for executing network applications that are hosted by a system.

### C. Example Embodiments for Applications and Interceptors

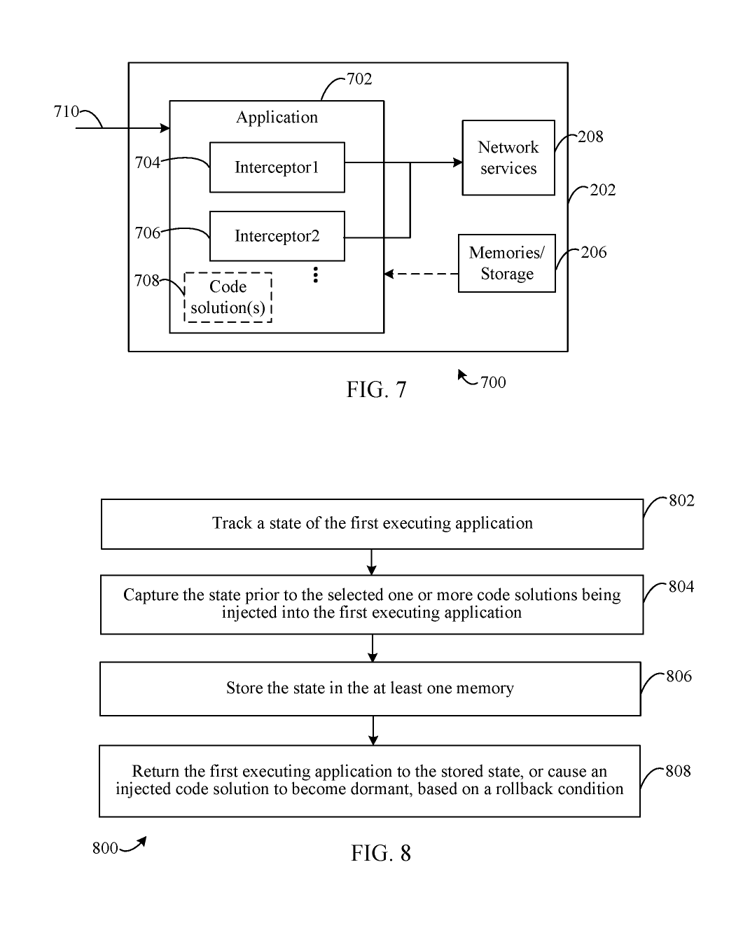

In embodiments, executing applications may include interceptors to provide data, information, and notifications to the network services (e.g., network services 208) for performance of their various functions. FIGS. 7 and 8 will now be described in this context.

Referring now to FIG. 7, a block diagram of a network services host system 700 (system 700) for resolving anomalies for network applications using code injection is shown, according to an example embodiment. As illustrated, system 700 includes network services host 202 (with network services 208 and memory 206 illustrated for brevity) described above with respect to FIG. 2. System 700 also includes an application 702 having an interceptor1 704 and an interceptor2 706 (although embodiments with additional interceptors, or a single interceptor, are contemplated herein).

Application 702 may be any type of application described herein executing on a host system, e.g., network services host 202. Application 702 may receive communications/requests 710 from client devices, such as client device 102 of FIG. 1. While not shown for illustrative clarity, communications/requests 710 from client devices may be provided to application 702 via network services 208. Communications/Requests 710 may be intercepted by interceptors such as interceptor1 704 and/or interceptor2 706. Interceptor1 704 and/or interceptor2 706 may be configured to provide communications/requests 710, data/information extracted therefrom, and/or indications thereof, to network services 208 for performance of the embodiments and techniques provided herein. An interceptor may also be configured to capture exceptions in application 702, or indicia thereof, as well as application state information and/or application context information which may be provided to network services 208. Interceptor1 704 and/or interceptor2 706 may also be any type of custom interceptor configured to detect or intercept different types of conditions, data, information, etc., specific to application 702.

In embodiments, interceptors may be provided from memory 206 as injected components, as similarly described herein for code solutions, or may be otherwise provided by to application 702 by network services 208 and/or network services host 202. In some embodiments, interceptors may be included by a developer of the application via developer system 114, and in such embodiments, interceptors may be provided to the developer via network services host 202 and/or network services administrator client 116.

Application 702 may include one or more injected code solutions 708, according to the embodiments described herein. While shown as being within application 702, injected code solutions may be implemented in different system layers, in a hypervisor, etc., in different embodiments. That is, as used herein, injecting a code solution into an executing application includes scenarios for injecting the code solution for the executing application for different locations/protocols/architecture portions within a host system.

As previously noted, application state tracker 220 is configured to track and store the state of application 702, which may include data/information from interceptor1 704 and/or interceptor2 706. When injected code solution(s) 708 are injected for application 702, the current application state is captured and saved by application state tracker 220.

Turning now to FIG. 8, a flowchart 800 for resolving anomalies for network applications using code injection is shown, in accordance with an example embodiment. Executing applications such as application 702, systems such as system 200 of FIG. 2, and/or code solutions such as code solution 500 of FIG. 5, as described herein, may operate according to flowchart 800. Flowchart 800 may be a further embodiment of any flowchart described herein. Further structural and operational examples will be apparent to persons skilled in the relevant art(s) based on the following description. Flowchart 800 is described as follows.

Flowchart 800 beings with step 802. In step 802, a state of the first executing application is tracked. For example, application state tracker 220 of system 200 is configured to track states of executing applications, such as application 702 executing on network services host 202. Application state tracker 220 is configured to utilize data and information provided by data collector 212, e.g., from interceptor1 704 and/or interceptor2 706, as described above. In one example, configuration information for application 702 (e.g., code solutions implemented, resource allocations for applications, data and/or types of data used by the application, etc.) may be used by application state tracker 220 to track a current state of an application.

In step 804, the state prior to the selected one or more code solutions being injected into the first executing application is captured. For instance, application state tracker 220 is configured to capture the current state of executing application 702 when injected code solution(s) 708 are provided for application 702. That is, based on the data and information described in step 802, application state tracker 220 is enabled to capture a current, real-time state of application 702 as it executes.

In step 806, the state is stored in the at least one memory. For example, the current state of application 702 that is captured in step 804 may be stored in memory 206 of system 200 by application state tracker 220. It is contemplated herein that more than one state of application 702 may be tracked, captured, and stored according to steps 802-806 when more than one injected code solution(s) 708 is provided for application 702.

In step 808, the first executing application is returned to the stored state, or an injected code solution is caused to become dormant, based on a rollback condition. A rollback, as used herein, includes returning an executing application to a prior state and/or configuration that existed before injection of one or more code solutions. For instance, application 702 may be provided with injected code solution(s) 708 as described herein to handle one or more anomalies for a given context. While in some embodiments injected code solution(s) 708 may be permanent or may persist while application 702 continues to execute, in other embodiments injected code solution(s) 708 may be rolled back or caused to become dormant based on rollback conditions/criteria. Dormant code solutions may also be permanent and activated for subsequent detections of the anomaly for which the dormant code solution was applied.

Rollbacks may be performed by solution service 216, application state tracker 220, and/or application 702, according to embodiments. Rollback conditions may include, without limitation, an expiration of a timer (e.g., in solution service 216, application state tracker 220, and/or application 702 (not shown)), a result of monitoring and analyzing subsequent notifications for additional or continued instances of the one or more anomalies as described herein, a result of monitoring and analyzing notifications for another executing application executed by the network services system, and/or a change in the application context associated with the first executing application (e.g., by data collector 212 and/or anomaly detector 214 of system 200).

Accordingly, an executing application may be serviced with a code solution(s) to address an anomaly(ies), and then be returned to a prior state when the anomaly(ies) is handled via rollback or be returned to prior operations when the code solution(s) becomes dormant.

### III. Example Computing Device Embodiments

Embodiments described herein may be implemented in hardware, or hardware combined with software and/or firmware. For example, embodiments described herein may be implemented as computer program code/instructions configured to be executed in one or more processors and stored in a computer readable storage medium. Alternatively, embodiments described herein may be implemented as hardware logic/electrical circuitry.

As noted herein, the embodiments described, including system 100 of FIG. 1, system 200 of FIG. 2, code solution 500 of FIG. 5, and system 700 of FIG. 7, along with any components and/or subcomponents thereof, as well as the flowcharts/flow diagrams described herein and/or further examples described herein, may be implemented in hardware, or hardware with any combination of software and/or firmware, including being implemented as computer program code configured to be executed in one or more processors and stored in a computer readable storage medium, or being implemented as hardware logic/electrical circuitry, such as being implemented together in a system-on-chip (SoC), a field programmable gate array (FPGA), or an application specific integrated circuit (ASIC). A SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

Embodiments described herein may be implemented in one or more computing devices similar to a mobile system and/or a computing device in stationary or mobile computer embodiments, including one or more features of mobile systems and/or computing devices described herein, as well as alternative features. The descriptions of computing devices provided herein are provided for purposes of illustration, and are not intended to be limiting. Embodiments may be implemented in further types of computer systems, as would be known to persons skilled in the relevant art(s).

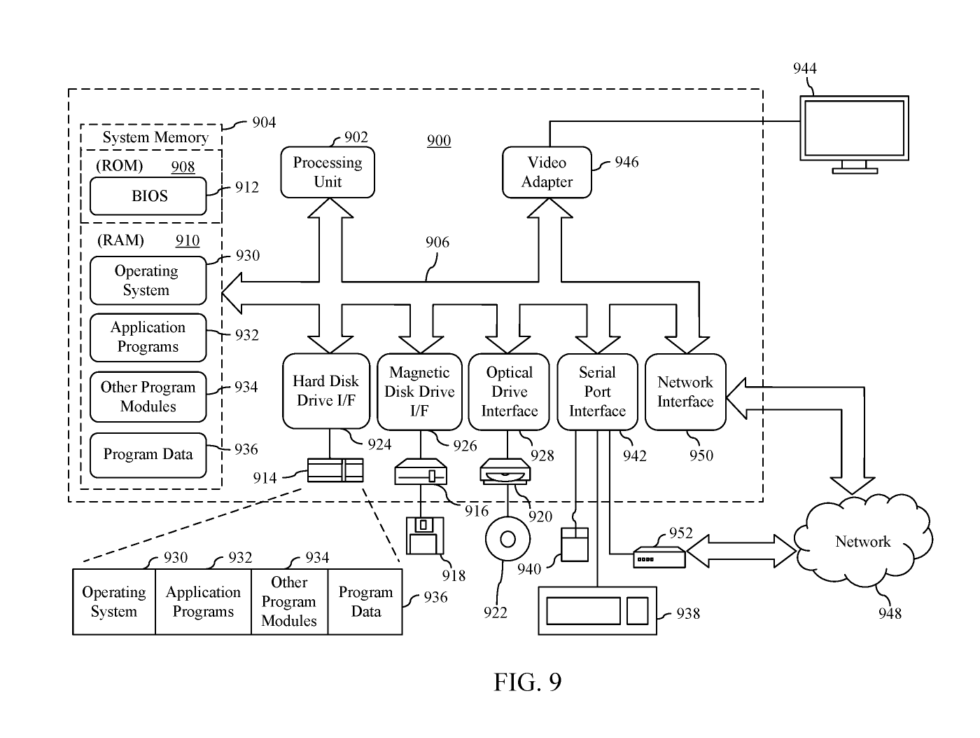

FIG. 9 depicts an exemplary implementation of a computing device 900 in which embodiments may be implemented. For example, embodiments described herein may be implemented in one or more computing devices similar to computing device 900 in stationary or mobile computer embodiments, including one or more features of computing device 900 and/or alternative features. The description of computing device 900 provided herein is provided for purposes of illustration, and is not intended to be limiting. Embodiments may be implemented in further types of computer systems and/or game consoles, etc., as would be known to persons skilled in the relevant art(s).

As shown in FIG. 9, computing device 900 includes one or more processors, referred to as processor circuit 902, a system memory 904, and a bus 906 that couples various system components including system memory 904 to processor circuit 902. Processor circuit 902 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 902 may execute program code stored in a computer readable medium, such as program code of operating system 930, application programs 932, other programs 934, etc. Bus 906 represents one or more of any of several types of bus structures, including a memory bus or memory controller, a peripheral bus, an accelerated graphics port, and a processor or local bus using any of a variety of bus architectures. System memory 904 includes read only memory (ROM) 908 and random access memory (RAM) 910. A basic input/output system 912 (BIOS) is stored in ROM 908.

Computing device 900 also has one or more of the following drives: a hard disk drive 914 for reading from and writing to a hard disk, a magnetic disk drive 916 for reading from or writing to a removable magnetic disk 918, and an optical disk drive 920 for reading from or writing to a removable optical disk 922 such as a CD ROM, DVD ROM, or other optical media. Hard disk drive 914, magnetic disk drive 916, and optical disk drive 920 are connected to bus 906 by a hard disk drive interface 924, a magnetic disk drive interface 926, and an optical drive interface 928, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 930, one or more application programs 932, other programs 934, and program data 936. Application programs 932 or other programs 934 may include, for example, computer program logic (e.g., computer program code or instructions) for implementing embodiments described herein, such as system 100 of FIG. 1, system 200 of FIG. 2, code solution 500 of FIG. 5, and system 700 of FIG. 7, along with any components and/or subcomponents thereof, as well as the plots and flowcharts/flow diagrams described herein and/or further examples described herein.

A user may enter commands and information into the computing device 900 through input devices such as keyboard 938 and pointing device 940. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 902 through a serial port interface 942 that is coupled to bus 906, but may be connected by other interfaces, such as a parallel port, game port, or a universal serial bus (USB).

A display screen 944 is also connected to bus 906 via an interface, such as a video adapter 946. Display screen 944 may be external to, or incorporated in computing device 900. Display screen 944 may display information, as well as being a user interface for receiving user commands and/or other information (e.g., by touch, finger gestures, virtual keyboard, etc.). In addition to display screen 944, computing device 900 may include other peripheral output devices (not shown) such as speakers and printers.

Computing device 900 is connected to a network 948 (e.g., the Internet) through an adaptor or network interface 950, a modem 952, or other means for establishing communications over the network. Modem 952, which may be internal or external, may be connected to bus 906 via serial port interface 942, as shown in FIG. 9, or may be connected to bus 906 using another interface type, including a parallel interface.

As used herein, the terms “computer program medium,” “computer-readable medium,” and “computer-readable storage medium,” etc., are used to refer to physical hardware media such as the hard disk associated with hard disk drive 914, removable magnetic disk 918, removable optical disk 922, other physical hardware media such as RAMs, ROMs, flash memory cards, digital video disks, zip disks, MEMs, nanotechnology-based storage devices, and further types of physical/tangible hardware storage media (including memory 920 of FIG. 9). Such computer-readable media and/or storage media are distinguished from and non-overlapping with communication media and propagating signals (do not include communication media and propagating signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 932 and other programs 934) may be stored on the hard disk, magnetic disk, optical disk, ROM, RAM, or other hardware storage medium. Such computer programs may also be received via network interface 950, serial port interface 942, or any other interface type. Such computer programs, when executed or loaded by an application, enable computing device 900 to implement features of embodiments discussed herein. Accordingly, such computer programs represent controllers of the computing device 900.

Embodiments are also directed to computer program products comprising computer code or instructions stored on any computer-readable medium or computer-readable storage medium. Such computer program products include hard disk drives, optical disk drives, memory device packages, portable memory sticks, memory cards, and other types of physical storage hardware.

### IV. Additional Example and Advantages

As described, systems and devices embodying the techniques herein may be configured and enabled in various ways to perform their respective functions. In embodiments, one or more of the steps or operations of any flowchart and/or flow diagram described herein may not be performed. Moreover, steps or operations in addition to or in lieu of those in any flowchart and/or flow diagram described herein may be performed. Further, in examples, one or more operations of any flowchart and/or flow diagram described herein may be performed out of order, in an alternate sequence, or partially (or completely) concurrently with each other or with other operations.

Furthermore, the described embodiments do not exist in software implementations for resolving anomalies for network applications using code injection, e.g., in cloud-based or non-cloud-based host system implementations. Current solutions require applications and/or host systems to be taken offline (i.e., be not executing or available) for software fixes, updates, and maintenance. Still further, the embodiments and techniques herein allow for real-time actions to be taken against anomalies as they happen for current contexts of applications, rather than reviewing support tickets or log files hours after an anomaly or issue occurs.

The additional examples and embodiments described in this Section may be applicable to examples disclosed in any other Section or subsection of this disclosure.

A system is described herein. The system may be a network services system configured and enabled in various ways to resolve anomalies for network applications using code injection, as described herein. The system includes one or more processors and one or more memories that store program instructions to be executed by the processor(s). The program instructions includes first instructions, second instructions, and third instructions. The first instructions are configured to monitor notifications for electronic communications incoming to executing applications on the network services system. The second instructions are configured to analyze the notifications, and identify one or more anomalies in the electronic communications for a first executing application of the executing applications based on the analysis. The third instructions are configured to determine an application context associated with the first executing application, select one or more code solutions from a set of code solutions to correspondingly apply against the one or more anomalies based on the application context associated with the first executing application and the one or more anomalies, each code solution in the set of code solutions comprising at least one of a code block or a code assembly and being configured to resolve a specific anomaly for executing applications, and inject the selected one or more code solutions into the first executing application.

In an embodiment of the system, the set of code solutions is stored in the at least one memory, and the program instructions further include fourth instructions configured to receive a generated code solution for an anomaly of the one or more anomalies, store the generated code solution as part of the set of code solutions in the at least one memory.

In an embodiment of the system, the second instructions are configured to identify an anomaly of the one or more anomalies for a second executing application of the applications based on a separate notifications analysis for the second executing application. In the embodiment, the third instructions are configured to determine an application context associated with the second executing application, select the code solution from the set of code solutions to apply against the anomaly of the one or more anomalies for the second executing application based on the application context associated with the second executing application and the anomaly of the one or more anomalies for the second executing application, and inject the selected code solution into the second executing application.

In an embodiment of the system, the program instructions further comprise fifth instructions configured to track a state of the first executing application and capture the state prior to the selected one or more code solutions being injected into the first executing application. The fifth instructions are also configured to store the state in the at least one memory and return the first executing application to the stored state, or cause an injected code solution to become dormant, based on a rollback condition.

In an embodiment of the system, the rollback condition includes one or more of an expiration of a timer, a result of monitoring and analyzing subsequent notifications for additional or continued instances of the one or more anomalies, a result of monitoring and analyzing notifications for another executing application executed by the network services system, or a change in the application context associated with the first executing application.

In an embodiment of the system, at least one of the code solutions is configured to cause one or more of limiting a number of requests from clients to the first executing application, ignoring one or more requests from clients to the first executing application, deferring one or more requests from clients to the first executing application, servicing requests from clients to the first executing application in an order of priority, reallocating a resource for the first executing application from another application, scaling a channel for the first executing application, or creating a new channel for a subservice related to the first executing application.

In an embodiment of the system, the third instructions are configured to determine the application context associated with the first executing application based on application information. The application information includes one or more of information related to a user associated with the electronic communications, an expected number for the electronic communications based on the first executing application, an actual number of the electronic communications for the first executing application, or a type of request associated with the electronic communications. In the embodiment, the third instructions are configured to select the one or more code solutions from the set of code solutions by comparing the application context associated with the first executing application with context metadata of the one or more code solutions.

A method is also described. The method may be for a network services system, and may be for resolving anomalies for network applications using code injection, as described herein. The method may be performed on or by any system described herein. The method includes identifying one or more anomalies in incoming electronic communications for a first executing application of one or more executing applications on the network services system, and determining an application context associated with the first executing application. The method also includes selecting one or more code solutions from a set of code solutions to correspondingly apply against the one or more anomalies based on the application context associated with the first executing application and the one or more anomalies, each code solution in the set of code solutions comprising at least one of a code block or a code assembly and being configured to resolve a specific anomaly for executing applications, and injecting the selected one or more code solutions into the first executing application.

In an embodiment, the method further includes receiving a generated code solution for an anomaly of the one or more anomalies, and storing the generated code solution as part of the set of code solutions in a memory.

In an embodiment, the method further includes identifying an anomaly of the one or more anomalies for a second executing application of the one or more executing applications based on a separate notifications analysis for the second executing application, and determining an application context associated with the second executing application. In the embodiment, the method also includes selecting the code solution from the set of code solutions to apply against the anomaly of the one or more anomalies based on that the application context associated with the second executing application the anomaly of the one or more anomalies for the second executing application, and injecting the selected code solution into the second executing application.

In an embodiment, the method further includes tracking a state of the first executing application, capturing the state prior to the selected one or more code solutions being injected into the first executing application, storing the state in at least one memory, and returning the first executing application to the stored state, or causing an injected code solution to become dormant, based on a rollback condition.

In an embodiment of the method, the rollback condition includes one or more of an expiration of a timer, a result of monitoring and analyzing subsequent notifications for additional or continued instances of the one or more anomalies, a result of monitoring and analyzing notifications for a second executing application executed by the network services system, or a change in the application context associated with the first executing application.

In an embodiment, subsequent to the code solution being injected, the method further includes one or more of limiting a number of requests from clients to the first executing application, ignoring one or more requests from clients to the first executing application, deferring one or more requests from clients to the first executing application, servicing requests from clients to the first executing application in an order of priority, reallocating a resource for the first executing application from another application, scaling a channel for the first executing application, or creating a new channel for a subservice related to the first executing application.

In an embodiment of the method, the application context associated with the first executing application is based on one or more of information related to a user associated with the electronic communications, an expected number for the electronic communications based on the first executing application, an actual number of the electronic communications for the first executing application, or a type of request associated with the electronic communications. In the embodiment, the method further includes comparing the application context associated with the first executing application with context metadata of the one or more code solutions.

In an embodiment, the method further includes providing interceptor program code instructions for the first executing application, the interceptor program code instructions configured to transmit notifications for electronic communications incoming to the first executing application, and receiving and analyzing the notifications prior to the identifying the one or more anomalies.

A computer-readable storage medium having program instructions recorded thereon that, when executed by a processing device, perform a method for a network services system is also described. The method includes monitoring notifications for electronic communications incoming to executing applications on the network services system, and analyze the notifications, and identifying one or more anomalies in the electronic communications for a first executing application of the executing applications based on the analysis. The method also includes determining an application context associated with the first executing application, selecting one or more code solutions from a set of code solutions to correspondingly apply against the one or more anomalies based on the application context associated with the first executing application and the one or more anomalies, each code solution in the set of code solutions comprising at least one of a code block or a code assembly and being configured to resolve a specific anomaly for executing applications, and injecting the selected one or more code solutions into the first executing application.

In an embodiment, the method further includes receiving a code solution for an anomaly of the one or more anomalies, and storing the code solution as part of the set of code solutions in a first memory prior to the selecting the one or more code solutions from the set of code solutions. In the embodiment, the method also includes identifying the anomaly of the one or more anomalies for a second executing application of the executing applications based on a subsequent notifications analysis after the injecting the selected one or more code solutions into the first executing application, selecting the code solution from the set of code solutions to apply against the anomaly of the one or more anomalies for the second executing application based on the application context associated with the second executing application and the anomaly of the one or more anomalies for the second executing application, and injecting the selected code solution into the second executing application.

In an embodiment, the method further includes tracking a state of the first executing application, and capturing the state prior to the selected one or more code solutions being injected into the first executing application. In the embodiment, the method also includes storing the state in a second memory, and returning the first executing application to the stored state, or causing an injected code solution to become dormant, based on a rollback condition. The rollback condition includes one or more of an expiration of a timer, a result of monitoring and analyzing subsequent notifications for additional or continued instances of the one or more anomalies, a result of monitoring and analyzing notifications for another executing application executed by the network services system, or a change in the application context associated with the first executing application.

In an embodiment, the code solution is configured to cause one or more of limiting a number of requests from clients to the first executing application, ignoring one or more requests from clients to the first executing application, deferring one or more requests from clients to the first executing application, servicing requests from clients to the first executing application in an order of priority, reallocating a resource for the application from another first executing application, scaling a channel for the first executing application, or creating a new channel for a subservice related to the first executing application.

In an embodiment, determining the application context associated with the first executing application includes determining the application context associated with the first executing application based on application information. In the embodiment, the application information includes one or more of information related to a user associated with the electronic communications, an expected number for the electronic communications based on the first executing application, an actual number of the electronic communications for the first executing application, or a type of request associated with the electronic communications.

### V. CONCLUSION

While various embodiments of the disclosed subject matter have been described above, it should be understood that they have been presented by way of example only, and not limitation. It will be understood by those skilled in the relevant art(s) that various changes in form and details may be made therein without departing from the spirit and scope of the embodiments as defined in the appended claims. Accordingly, the breadth and scope of the disclosed subject matter should not be limited by any of the above-described exemplary embodiments, but should be defined only in accordance with the following claims and their equivalents.

What is claimed is:

1. A network services system comprising:
at least one memory configured to store program instructions; and
at least one processor configured to execute the program instructions, the program instructions including:
first instructions configured to:
monitor notifications for electronic communications incoming to executing applications on the network services system;
second instructions configured to:
analyze the notifications; and
identify one or more anomalies in the electronic communications for a first executing application of the executing applications based on the analysis; and
third instructions configured to:
determine an application context associated with the first executing application;
select one or more code solutions from a set of code solutions to correspondingly apply against the one or more anomalies based on the application context associated with the first executing application and the one or more anomalies, each code solution in the set of code solutions comprising at least one of a code block or a code assembly and being configured to resolve a specific anomaly for executing applications; and
inject the selected one or more code solutions into the first executing application.

2. The network services system of claim 1, wherein the set of code solutions is stored in the at least one memory;
the program instructions further comprising fourth instructions configured to:
receive a generated code solution for an anomaly of the one or more anomalies; and
store the generated code solution as part of the set of code solutions in the at least one memory.

3. The network services system of claim 1, wherein the second instructions are configured to identify an anomaly of the one or more anomalies for a second executing application of the applications based on a separate notifications analysis for the second executing application; and
wherein the third instructions are configured to:
determine an application context associated with the second executing application;
select the code solution from the set of code solutions to apply against the anomaly of the one or more anomalies for the second executing application based on the application context associated with the second executing application and the anomaly of the one or more anomalies for the second executing application; and
inject the selected code solution into the second executing application.

4. The network services system of claim 1, wherein the program instructions further comprise fifth instructions configured to:
track a state of the first executing application;
capture the state prior to the selected one or more code solutions being injected into the first executing application;
store the state in the at least one memory; and
return the first executing application to the stored state, or cause an injected code solution to become dormant, based on a rollback condition.

5. The network services system of claim 4, wherein the rollback condition includes one or more of:
an expiration of a timer;
a result of monitoring and analyzing subsequent notifications for additional or continued instances of the one or more anomalies;
a result of monitoring and analyzing notifications for another executing application executed by the network services system; or
a change in the application context associated with the first executing application.

6. The network services system of claim 1, wherein at least one of the code solutions is configured to cause one or more of:
limiting a number of requests from clients to the first executing application;
ignoring one or more requests from clients to the first executing application;
deferring one or more requests from clients to the first executing application;
servicing requests from clients to the first executing application in an order of priority;
reallocating a resource for the first executing application from another application;
scaling a channel for the first executing application; or
creating a new channel for a subservice related to the first executing application.

7. The network services system of claim 1, wherein the third instructions are configured to determine the application context associated with the first executing application based on application information, the application information including one or more of:
information related to a user associated with the electronic communications;
an expected number for the electronic communications based on the first executing application;
an actual number of the electronic communications for the first executing application; or
a type of request associated with the electronic communications; and
wherein the third instructions are configured to select the one or more code solutions from the set of code solutions by comparing the application context associated with the first executing application with context metadata of the one or more code solutions.

8. A method for a network services system, the method comprising:
identifying one or more anomalies in incoming electronic communications for a first executing application of one or more executing applications on the network services system;
determining an application context associated with the first executing application;
selecting one or more code solutions from a set of code solutions to correspondingly apply against the one or more anomalies based on the application context associated with the first executing application and the one or more anomalies, each code solution in the set of code solutions comprising at least one of a code block or a code assembly and being configured to resolve a specific anomaly for executing applications; and
injecting the selected one or more code solutions into the first executing application.

9. The method claim 8, further comprising:
receiving a generated code solution for an anomaly of the one or more anomalies; and
storing the generated code solution as part of the set of code solutions in a memory.

10. The method of claim 8, further comprising:
identifying an anomaly of the one or more anomalies for a second executing application of the one or more executing applications based on a separate notifications analysis for the second executing application;
determining an application context associated with the second executing application;
selecting the code solution from the set of code solutions to apply against the anomaly of the one or more anomalies based on that the application context associated with the second executing application the anomaly of the one or more anomalies for the second executing application; and
injecting the selected code solution into the second executing application.

11. The method of claim 8, further comprising:
tracking a state of the first executing application;
capturing the state prior to the selected one or more code solutions being injected into the first executing application;
storing the state in at least one memory; and
returning the first executing application to the stored state, or causing an injected code solution to become dormant, based on a rollback condition.

12. The method of claim 11, wherein the rollback condition includes one or more of:
an expiration of a timer;
a result of monitoring and analyzing subsequent notifications for additional or continued instances of the one or more anomalies;
a result of monitoring and analyzing notifications for a second executing application executed by the network services system; or
a change in the application context associated with the first executing application.

13. The method of claim 8, further comprising performing one or more of the following subsequent to the code solution being injected:
limiting a number of requests from clients to the first executing application;
ignoring one or more requests from clients to the first executing application;
deferring one or more requests from clients to the first executing application;
servicing requests from clients to the first executing application in an order of priority;
reallocating a resource for the first executing application from another application;
scaling a channel for the first executing application; or
creating a new channel for a subservice related to the first executing application.

14. The method of claim 8, wherein the application context associated with the first executing application is based on one or more of:
information related to a user associated with the electronic communications;
an expected number for the electronic communications based on the first executing application;
an actual number of the electronic communications for the first executing application; or
a type of request associated with the electronic communications; and
wherein the method further comprises: comparing the application context associated with the first executing application with context metadata of the one or more code solutions.

15. The method of claim 8, further comprising:
providing interceptor program code instructions for the first executing application, the interceptor program code instructions configured to transmit notifications for electronic communications incoming to the first executing application; and
receiving and analyzing the notifications prior to the identifying the one or more anomalies.

16. A computer-readable storage medium having program instructions recorded thereon that, when executed by a processing device, perform a method for a network services system, the method comprising:
monitoring notifications for electronic communications incoming to executing applications on the network services system;
analyzing the notifications;
identifying one or more anomalies in the electronic communications for a first executing application of the executing applications based on the analysis;
determining an application context associated with the first executing application;
selecting one or more code solutions from a set of code solutions to correspondingly apply against the one or more anomalies based on the application context associated with the first executing application and the one or more anomalies, each code solution in the set of code solutions comprising at least one of a code block or a code assembly and being configured to resolve a specific anomaly for executing applications; and
injecting the selected one or more code solutions into the first executing application.

17. The computer-readable storage medium of claim 16, wherein the method further comprises:
receiving a code solution for an anomaly of the one or more anomalies;
storing the code solution as part of the set of code solutions in a first memory prior to the selecting the one or more code solutions from the set of code solutions;
identifying the anomaly of the one or more anomalies for a second executing application of the executing applications based on a subsequent notifications analysis after the injecting the selected one or more code solutions into the first executing application;
selecting the code solution from the set of code solutions to apply against the anomaly of the one or more anomalies for the second executing application based on the application context associated with the second executing application and the anomaly of the one or more anomalies for the second executing application; and
injecting the selected code solution into the second executing application.

18. The computer-readable storage medium of claim 16, wherein the method further comprises:
tracking a state of the first executing application;
capturing the state prior to the selected one or more code solutions being injected into the first executing application;
storing the state in a second memory; and
returning the first executing application to the stored state, or causing an injected code solution to become dormant, based on a rollback condition;
the rollback condition including one or more of:
an expiration of a timer;
a result of monitoring and analyzing subsequent notifications for additional or continued instances of the one or more anomalies;
a result of monitoring and analyzing notifications for another executing application executed by the network services system; or
a change in the application context associated with the first executing application.

19. The computer-readable storage medium of claim 16, wherein the code solution is configured to cause one or more of:
limiting a number of requests from clients to the first executing application;
ignoring one or more requests from clients to the first executing application;
deferring one or more requests from clients to the first executing application;
servicing requests from clients to the first executing application in an order of priority;
reallocating a resource for the application from another first executing application;
scaling a channel for the first executing application; or
creating a new channel for a subservice related to the first executing application.

20. The computer-readable storage medium of claim 16, wherein the determining the application context associated with the first executing application includes determining the application context associated with the first executing application based on application information;
the application information including one or more of:
information related to a user associated with the electronic communications;
an expected number for the electronic communications based on the first executing application;
an actual number of the electronic communications for the first executing application; or
a type of request associated with the electronic communications.
